(19) United States
(12) Patent Application Publication
(10) Pub. No.: US 2025/0233269 A1
(43) Pub. Date: Jul. 17, 2025

(54) SECONDARY BATTERY

(71) Applicant: SAMSUNG SDI CO., LTD., Yongin-si (KR)

(72) Inventors: Cheol Hee HWANG, Suwon-si (KR); Dong Hyun KIM, Suwon-si (KR)

(21) Appl. No.: 18/911,442

(22) Filed: Oct. 10, 2024

(30) Foreign Application Priority Data
Jan. 15, 2024 (KR) 10-2024-0005888

(51) Int. Cl. H01M 50/474; H01M 4/131; H01M 4/525; H01M 4/58; H01M 10/04

(52) U.S. Cl. CPC H01M 50/474; H01M 4/131; H01M 4/525; H01M 4/5825; H01M 10/0431

(57) ABSTRACT

A secondary battery includes a first electrode assembly including a first positive electrode plate including a first positive electrode active material layer thereon, the first positive electrode active material layer including a first positive electrode active material, a first negative electrode plate facing the first positive electrode plate, and a first separator between the first positive electrode plate and the first negative electrode plate; a second electrode assembly including a second positive electrode plate including a second positive electrode active material layer thereon, the second positive electrode active material layer including a second positive electrode active material different from the first positive electrode active material, a second negative electrode plate facing the second positive electrode plate, and a second separator between the second positive electrode plate and the second negative electrode plate; and an assembly separator separating the first electrode assembly and the second electrode assembly from each other.

### CROSS-REFERENCE TO RELATED APPLICATION

The present application claims priority and the benefit of Korean Patent Application No. 10-2024-0005888, filed on Jan. 15, 2024, in the Korean Intellectual Property Office, the entire disclosure of which is incorporated herein by reference.

### BACKGROUND

### 1. Field

Embodiments relate to a secondary battery.

### 2. Description of the Related Art

In general, due to the recent proliferation of electronic devices using batteries, such as mobile phones, notebook computers, and electric vehicles, the demand for secondary batteries having high energy density and high capacity has rapidly increased. Accordingly, research and development for improving the performance of a lithium secondary battery has been considered.

A lithium secondary battery is a battery including a positive electrode and a negative electrode including an active material capable of intercalating and deintercalating lithium ions, and an electrolyte solution, and generates energy through oxidation/reduction reactions when lithium ions are intercalated/deintercalated at the positive and negative electrodes.

The above-described information disclosed in the technology that forms the background of the present disclosure is only intended to improve understanding of the background of the present disclosure, and thus may include information that does not constitute the related art.

### SUMMARY

The embodiments may be realized by providing a secondary battery including at least one first electrode assembly including at least one first positive electrode plate including a first positive electrode active material layer thereon, the first positive electrode active material layer including a first positive electrode active material, at least one first negative electrode plate facing the at least one first positive electrode plate, and a first separator between the at least one first positive electrode plate and the at least one first negative electrode plate; a second electrode assembly including a second positive electrode plate including a second positive electrode active material layer thereon, the second positive electrode active material layer including a second positive electrode active material different from the first positive electrode active material, a second negative electrode plate facing the second positive electrode plate, and a second separator between the second positive electrode plate and the second negative electrode plate; and an assembly separator separating the at least one first electrode assembly and the second electrode assembly from each other.

The at least one first electrode assembly and the second electrode assembly may be alternately stacked.

The at least one first electrode assembly may include a pair of first electrode assemblies, and the second electrode assembly may be between the pair of first electrode assemblies.

The at least one first positive electrode plate may include a plurality of first positive electrode plates, the at least one first negative electrode plate may include a plurality of first negative electrode plates, and the plurality of first positive electrode plates and the plurality of first negative electrode plates may be alternately stacked.

The at least one first positive electrode plate and the at least one first negative electrode plate may be wound around a winding axis.

The first positive electrode active material may include lithium-iron-phosphate oxide (LiFePO₄, LFP) or lithium-manganese-iron-phosphate oxide (LiMnFePO₄, LMFP), and the second positive electrode active material may include lithium-nickel-cobalt-manganese oxide (LiNiₓCo_{y}Mn_{z}O₂, NCM), in which 0<x<1, 0<y<1, 0<z<1, and x+y+z=1.

The first positive electrode active material layer may further include a first positive electrode conductive material, the second positive electrode active material layer may further include a second positive electrode conductive material, and an amount of the first positive electrode conductive material included in the first positive electrode active material layer may be greater than an amount of the second positive electrode conductive material included in the second positive electrode active material layer.

The amount of the first positive electrode conductive material included in the first positive electrode active material layer may be 1.2 wt % or more and 3 wt % or less, based on a total weight of the first positive electrode active material layer, and the amount of the second positive electrode conductive material included in the second positive electrode active material layer may be 1 wt % or more and 1.3 wt % or less, based on a total weight of the second positive electrode active material layer.

The first positive electrode active material layer may further include a first positive electrode binder, the second positive electrode active material layer may further include a second positive electrode binder, and an amount of the first positive electrode binder included in the first positive electrode active material layer may be greater than an amount of the second positive electrode binder included in the second positive electrode active material layer.

The amount of the first positive electrode binder included in the first positive electrode active material layer may be 2.2 wt % or more and 3.8 wt % or less, based on a total weight of the first positive electrode active material layer, and the amount of the second positive electrode binder included in the second positive electrode active material layer may be 1.2 wt % or more and 1.5 wt % or less, based on a total weight of the second positive electrode active material layer.

The at least one first negative electrode plate may include a first negative electrode active material layer thereon, the first negative electrode active material layer including a first negative electrode active material, the second negative electrode plate may include a second negative electrode active material layer thereon, the second negative electrode active material layer including a second negative electrode active material, and the first negative electrode active material and the second negative electrode active material may be identical.

Each of the first negative electrode active material and the second negative electrode active material may include graphite or silicon (Si).

The assembly separator may include a first assembly separator surrounding the at least one first electrode assembly; and a second assembly separator surrounding the second electrode assembly.

The first assembly separator may be connected to an end portion of the first separator, and may extend along a circumferential surface of the at least one first electrode assembly.

The first assembly separator may be separated from the first separator, and may be at least partially between the at least one first electrode assembly and the second electrode assembly.

The at least one first electrode assembly may further include a first positive electrode tab extending from the at least one first positive electrode plate to the outside of the first assembly separator; and a first negative electrode tab extending from the at least one first negative electrode plate to the outside of the first assembly separator.

The first assembly separator may include a pair of first open surfaces respectively facing opposite surfaces of the at least one first electrode assembly, and the first positive electrode tab and the first negative electrode tab may extend to the outside of the first assembly separator through different first open surfaces.

The first assembly separator may include a pair of first open surfaces respectively facing opposite surfaces of the at least one first electrode assembly, and the first positive electrode tab and the first negative electrode tab may extend to the outside of the first assembly separator through the same first open surface.

The embodiments may be realized by providing a secondary battery including a plurality of assembly modules each including a pair of first electrode assemblies having a first positive electrode active material, a second electrode assembly having a second positive electrode active material different from the first positive electrode active material and between the pair of first electrode assemblies, and an assembly separator separating the pair of first electrode assemblies and the second electrode assembly from each other, wherein the plurality of assembly modules are stacked side by side in one direction.

### BRIEF DESCRIPTION OF THE DRAWINGS

Features will be apparent to those of skill in the art by describing in detail exemplary embodiments with reference to the attached drawings in which:

FIG. 1 is a perspective view schematically illustrating a configuration of a secondary battery according to one embodiment;

FIG. 2 is a cross-sectional view taken along line A-A′ of FIG. 1;

FIG. 3 is a view illustrating a modified example of a first assembly separator and a second assembly separator illustrated in FIG. 2;

FIG. 4 is a cross-sectional view taken along line B-B′ of FIG. 1;

FIG. 5 is a perspective view illustrating a modified example of a first positive electrode tab, a first negative electrode tab, a second positive electrode tab, and a second negative electrode tab illustrated in FIGS. 1 and 4;

FIG. 6 is a cross-sectional view illustrating the modified example of the first positive electrode tab, the first negative electrode tab, the second positive electrode tab, and the second negative electrode tab illustrated in FIGS. 1 and 4;

FIG. 7 is a cross-sectional view schematically illustrating a configuration of a secondary battery according to another embodiment;

FIG. 8 is a view illustrating a modified example of a first assembly separator and a second assembly separator illustrated in FIG. 7;

FIG. 9 is a perspective view schematically illustrating a configuration of a secondary battery according to another embodiment; and

FIG. 10 is a perspective view schematically illustrating a configuration of a secondary battery according to another embodiment.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the terms “or” and “and/or” are not exclusive terms, and include any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” or “A or B” is stated, it means A, B, or A and B, unless otherwise stated. That is, “and/or” and “or” include any or all combinations of a plurality of items enumerated. When “C to D” is stated, it means C or more and D or less, unless otherwise specified.

The terms used in the present specification are for describing embodiments of the present disclosure and are not intended to limit the present disclosure.

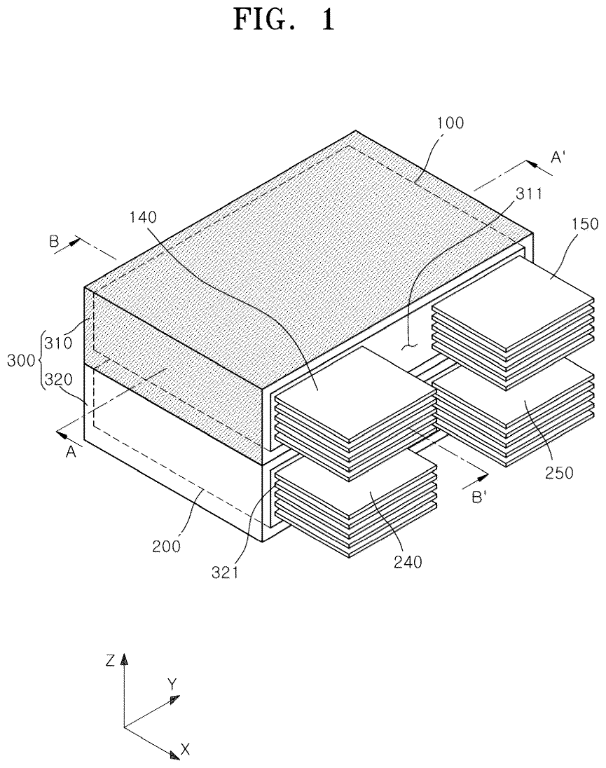

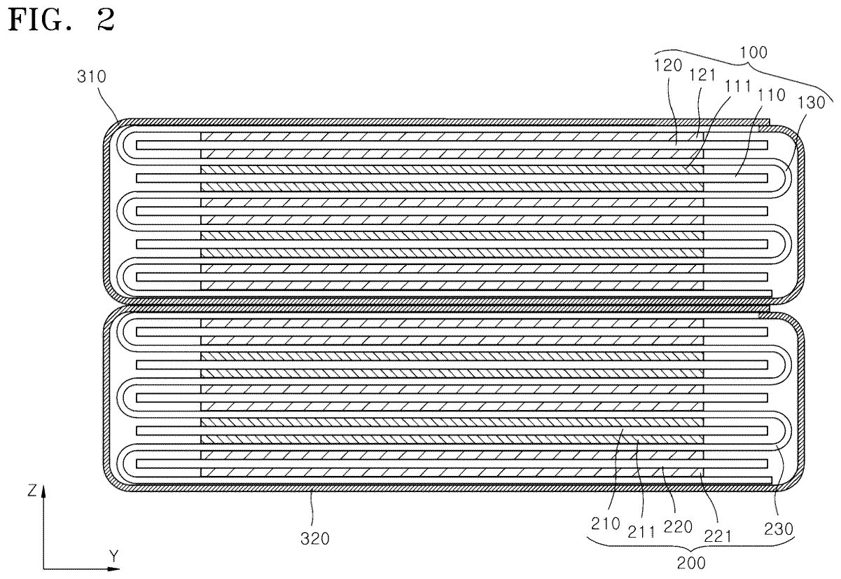

FIG. 1 is a perspective view schematically illustrating a configuration of a secondary battery according to one embodiment, and FIG. 2 is a cross-sectional view taken along line A-A′ of FIG. 1.

A forward/backward direction described below may be a direction parallel to an X-axis based on FIG. 1, a horizontal direction may be a direction parallel to a Y-axis direction based on FIG. 1, and a vertical direction may be a direction parallel to a Z-axis direction based on FIG. 1.

Referring to FIGS. 1 and 2, the secondary battery according to the present embodiment may include a (e.g., at least one) first electrode assembly 100, a second electrode assembly 200, and an assembly separator 300.

The first electrode assembly 100 and the second electrode assembly 200 may each function as a unit structure that performs power charging and discharging operations in the secondary battery.

The first electrode assembly 100 and the second electrode assembly 200 may be alternately stacked in one direction. Hereinafter, a case in which the first electrode assembly 100 and the second electrode assembly 200 are stacked in the vertical direction as illustrated in FIG. 1 will be described as an example. In an implementation, the first electrode assembly 100 and the second electrode assembly 200 may be stacked in the forward/backward direction or the horizontal direction. In addition, the first electrode assembly 100 is illustrated in FIG. 1 as being on the second electrode assembly 200, or the second electrode assembly 200 can be on the first electrode assembly 100.

The first electrode assembly 100 may include a (e.g., at least one) first positive electrode plate 110, a (e.g., at least one) first negative electrode plate 120, and a first separator 130.

The first positive electrode plate 110 may function as a positive electrode of the first electrode assembly 100. The first positive electrode plate may be formed in the form of a foil including a metal material such as aluminum or an aluminum alloy.

A plurality of first positive electrode plates 110 may be provided. The plurality of first positive electrode plates 110 may be stacked (e.g., side by side) in the vertical direction. A pair of adjacent first positive electrode plates 110 may be spaced apart from each other by a predetermined interval.

The type, size, and shape of the first positive electrode plate 110 may be suitable types, sizes, and shapes, as long as the first positive electrode plate 110 has conductivity and does not cause chemical changes in the secondary battery.

A first positive electrode active material layer 111 may be on the first positive electrode plate 110. The first positive electrode active material layer 111 may be on opposite surfaces of the first positive electrode plate 110 as illustrated in FIG. 2, or alternatively, may be on only one surface of the first positive electrode plate 110.

The first positive electrode active material layer 111 may include a first positive electrode active material.

The first positive electrode active material may include a compound (lithiated intercalation compound) capable of reversibly intercalating and deintercalating lithium. In an implementation, the first positive electrode active material may include a composite oxide of lithium and a metal, e.g., cobalt, manganese, nickel, iron, or a combination thereof.

In an implementation, the first positive electrode active material may include lithium-iron-phosphate oxide (LiFePO₄, LFP) or lithium-manganese-iron-phosphate oxide (LiMnFePO₄, LMFP). In an implementation, the first positive electrode active material may include only one of LiFePO₄ and LiMnFePO₄, or may also include all of LiFePO₄ and LiMnFePO₄. LiFePO₄ and LiMnFePO₄ may have excellent cycle characteristics and thermal properties. Accordingly, the first electrode assembly 100 may help ensure stability during charging and discharging operations of the secondary battery.

The first positive electrode active material layer 111 may further include a first positive electrode conductive material.

The first positive electrode conductive material may impart conductivity to the first positive electrode active material layer 111, and a suitable electrically conductive material that does not cause a chemical change in the battery may be used. Examples of the first positive electrode conductive material may include a carbon material, e.g., natural graphite, artificial graphite, carbon black, acetylene black, ketjen black, carbon fiber, carbon nanofiber, carbon nanotubes, or the like; a metal material, e.g., a metal powder or a metal fiber including copper, nickel, aluminum, silver, or the like; a conductive polymer, e.g., a polyphenylene; or a mixture thereof.

In an implementation, an amount of the first positive electrode conductive material included in the first positive electrode active material layer may be, e.g., 1.2 wt % or more and 3 wt % or less, based on a total weight of the first positive electrode active material layer 111, (100 wt % of the first positive electrode active material layer 111).

In an implementation, the first positive electrode active material layer 111 may further include a first positive electrode binder.

The first positive electrode binder may help adhere particles constituting the first positive electrode active material to each other well, and adhere the first positive electrode active material to the first positive electrode plate 110 well.

Examples of the first positive electrode binder may include a non-aqueous binder, an aqueous binder, a dry binder, or a combination thereof.

The non-aqueous binder may include, e.g., polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include, e.g., styrene-butadiene rubber, (meth)acrylated styrene-butadiene rubber, (meth)acrylonitrile-butadiene rubber, (meth)acrylic rubber, butyl rubber, a fluororubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenolic resin, an epoxy resin, polyvinyl alcohol, or a combination thereof.

In an implementation, the aqueous binder may be used as the first positive electrode binder, and a cellulose compound capable of imparting viscosity may be further included. The cellulose compound may include, e.g., carboxymethyl cellulose, hydroxypropylmethyl cellulose, methyl cellulose, or alkali metal salts thereof. As the alkali metal, Na, K, or Li may be used.

The dry binder may be a fibrous polymer material, e.g., polytetrafluoroethylene, polyvinylidene fluoride, a polyvinylidene fluoride-hexafluoropropylene copolymer, polyethylene oxide, or a combination thereof.

The amount of the first positive electrode binder may be 2.2 wt % or more and 3.8 wt % or less, based on the total weight of the first positive electrode active material layer 111, (100 wt % of the first positive electrode active material layer 111).

The first negative electrode plate 120 may function as a negative electrode of the first electrode assembly 100. The first negative electrode plate 120 may be in the form of a foil including a metal material such as copper, a copper alloy, nickel, or a nickel alloy.

A plurality of first negative electrode plates 120 may be provided. The plurality of first negative electrode plates 120 may be stacked (e.g., side by side) in the vertical direction. Each of the first negative electrode plates 120 may be between a pair of adjacent first positive electrode plates 110. In an implementation, the first positive electrode plate 110 and the first negative electrode plate 120 may be alternately stacked in the vertical direction. The first negative electrode plate 120 may be spaced apart from the first positive electrode plate 110 by a predetermined interval to face the first positive electrode plate 110.

The type, size, and shape of the first negative electrode plate 120 may be suitable types, sizes, and shapes, as long as the first negative electrode plate 120 has conductivity and does not cause chemical changes in the secondary battery.

A first negative electrode active material layer 121 may be on the first negative electrode plate 120. The first negative electrode active material layer 121 may be on opposite surfaces of the first negative electrode plate 120 as illustrated in FIG. 2, or alternatively, may be on only one surface of the first negative electrode plate 120.

The first negative electrode active material layer 121 may include a first negative electrode active material.

The first negative electrode active material may include a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon negative electrode active material, e.g., crystalline carbon, amorphous carbon, or a combination thereof. Examples of the crystalline carbon may include graphite such as amorphous, plate-shaped, flake-shaped, spherical-shaped or fiber-shaped natural graphite or artificial graphite. Examples of the amorphous carbon may include soft carbon or hard carbon, a mesophase pitch carbonized product, calcined coke, and the like.

The lithium metal alloy may be an alloy of lithium and a metal, e.g., Na, K, Rb, Cs, Fr, Be, Mg, Ca, Sr, Si, Sb, Pb, In, Zn, Ba, Ra, Ge, Al, or Sn.

A Si negative electrode active material or a Sn negative electrode active material may be used as the material capable of doping and dedoping lithium. The Si negative electrode active material may include silicon, a silicon-carbon composite, SiOₓ (0<x<2), a Si-Q alloy (in which Q is an alkali metal, an alkaline-earth metal, a Group 13 element, a Group 14 element (excluding Si), a Group 15 element, a Group 16 element, a transition metal, a rare-earth element, or a combination thereof), or a combination thereof. The Sn negative electrode active material may include Sn, SnO₂, a Sn alloy, or a combination thereof.

The silicon-carbon composite may be a composite of silicon and amorphous carbon. In an implementation, the silicon-carbon composite may be in the form of silicon particles and amorphous carbon coated on the surface of the silicon particles. In an implementation, the silicon-carbon composite may include a secondary particle (core) in which silicon primary particles are agglomerated and an amorphous carbon coating layer (shell) on the surface of the secondary particle. The amorphous carbon may also be between the silicon primary particles, e.g., the silicon primary particles may be coated with amorphous carbon. The secondary particles may be dispersed in an amorphous carbon matrix.

The silicon-carbon composite may further include crystalline carbon. In an implementation, the silicon-carbon composite may include a core including crystalline carbon and silicon particles, and an amorphous carbon coating layer located on the surface of the core.

The Si negative electrode active material or the Sn negative electrode active material may be used by being mixed with a carbon negative electrode active material.

The first negative electrode active material layer 121 may further include a first negative electrode conductive material and a first negative electrode binder.

The first negative electrode conductive material may impart conductivity to the first negative electrode active material layer 121, and a suitable electrically conductive material that does not cause a chemical change in the battery may be used. Examples of the first negative electrode conductive material may include a carbon material such as natural graphite, artificial graphite, carbon black, acetylene black, ketjen black, carbon fiber, carbon nanofiber, carbon nanotubes, or the like; a metal material such as a metal powder or a metal fiber including copper, nickel, aluminum, silver, or the like; a conductive polymer such as a polyphenylene; or a mixture thereof.

The first negative electrode binder may help adhere particles constituting the first negative electrode active material to each other well, and adhere the first negative electrode active material to the first negative electrode plate 120 well.

Examples of the first negative electrode binder may include a non-aqueous binder, an aqueous binder, a dry binder, or a combination thereof.

The non-aqueous binder may include, e.g., polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include, e.g., styrene-butadiene rubber, (meth)acrylated styrene-butadiene rubber, (meth)acrylonitrile-butadiene rubber, (meth)acrylic rubber, butyl rubber, a fluororubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenolic resin, an epoxy resin, polyvinyl alcohol, or a combination thereof.

In an implementation, the aqueous binder may be used as the first positive electrode binder, and a cellulose compound capable of imparting viscosity can be further included. The cellulose compound may include carboxymethyl cellulose, hydroxypropylmethyl cellulose, methyl cellulose, or alkali metal salts thereof. As the alkali metal, Na, K, or Li may be used.

The dry binder may be a fibrous polymer material, e.g., polytetrafluoroethylene, polyvinylidene fluoride, a polyvinylidene fluoride-hexafluoropropylene copolymer, polyethylene oxide, or a combination thereof.

The first separator 130 may be between the first positive electrode plate 110 and the first negative electrode plate 120. The first separator 130 may help prevent a short circuit between the first positive electrode plate 110 and the first negative electrode plate 120 while allowing the movement of lithium ions between the first positive electrode plate 110 and the first negative electrode plate 120.

The first separator 130 may be made of polyethylene, polypropylene, polyvinylidene fluoride, or a multilayer film of two or more layers thereof, or be made of a mixed multilayer film, such as, a polyethylene/polypropylene double-layered separator, a polyethylene/polypropylene/polyethylene three-layered separator, and a polypropylene/polyethylene/polypropylene three-layered separator.

The first separator 130 may include a porous substrate, and a coating layer including an organic material, an inorganic material, or a combination thereof on one surface or opposite surfaces of the porous substrate.

The porous substrate may be a polymer film of a homopolymer, or a copolymer or mixture of two or more of polyolefins such as polyethylene, polypropylene, and the like, a polyester such as polyethylene terephthalate, polybutylene terephthalate, or the like, polyacetal, polyamide, polyimide, polycarbonate, polyetheretherketone, polyaryletherketone, polyetherimide, polyamideimide, polybenzimidazole, polyether sulfone, polyphenylene oxide, a cyclic olefin copolymer, polyphenylene sulfide, polyethylene naphthalate, glass fiber, Teflon, or polytetrafluoroethylene.

The organic material may include a polyvinylidene fluoride polymer or a (meth)acrylic polymer.

The inorganic material may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The organic and inorganic materials may be present by being mixed in one coating layer or may be present in a form in which a coating layer including organic materials and a coating layer including inorganic materials are laminated.

The first separator 130 may be formed as a single piece. The first separator 130 may be bent in a zigzag shape so as to be between the electrodes.

In an implementation, a plurality of first separators 130 may be provided. In this case, the plurality of first separators 130 may be individually disposed between the first positive electrode plate 110 and the first negative electrode plate 120 that are adjacent to each other.

The second electrode assembly 200 may include a second positive electrode plate 210, a second negative electrode plate 220, and a second separator 230.

The second positive electrode plate 210 may function as a positive electrode of the second electrode assembly 200. The second positive electrode plate 210 may be in the form of a foil including a metal material such as aluminum or an aluminum alloy.

A plurality of second positive electrode plates 210 may be provided. The plurality of second positive electrode plates 210 may be stacked (e.g., side by side) in the vertical direction. A pair of adjacent second positive electrode plates 210 may be spaced apart from each other by a predetermined interval.

The type, size, and shape of the second positive electrode plate 210 may be suitable types, sizes, and shapes as long as the second positive electrode plate 210 has conductivity and does not cause chemical changes in the secondary battery.

A second positive electrode active material layer 211 may be on the second positive electrode plate 210. The second positive electrode active material layer 211 may be on opposite surfaces of the second positive electrode plate 210 as illustrated in FIG. 2, or alternatively, may be on only one surface of the second positive electrode plate 210.

The second positive electrode active material layer 211 may include a second positive electrode active material.

The second positive electrode active material may include a compound (lithiated intercalation compound) capable of reversibly intercalating and deintercalating lithium. In an implementation, the second positive electrode active material may include a composite oxide of lithium and a metal, e.g., cobalt, manganese, nickel, iron, or a combination thereof.

The second positive electrode active material may be a material different from the first positive electrode active material. In an implementation, the second positive electrode active material may include a lithium-nickel-cobalt-manganese oxide (LiNiₓCo_{y}Mn_{z}O₂, NCM). In an implementation, conditions of 0<x<1, 0<y<1, 0<z<1, and x+y+z=1 may be satisfied. In an implementation, the second positive electrode active material may include LiNi_{0.5}Co_{0.02}Mn_{0.3}O₂(NCM523) or LiNi_{0.6}Co_{0.02}Mn_{0.2}O₂ (NCM622). LiNiₓCo_{y}Mn_{z}O₂ may have a relatively higher energy capacity than LiFePO₄ and LiMnFePO₄. Accordingly, the second electrode assembly 200 may help improve energy density of the secondary battery.

The second positive electrode active material layer 211 may further include a second positive electrode conductive material.

The second positive electrode conductive material may impart conductivity to the second positive electrode active material layer 211, and a suitable electrically conductive material that does not cause a chemical change in the battery may be used. Examples of the second positive electrode conductive material may include a carbon material such as natural graphite, artificial graphite, carbon black, acetylene black, ketjen black, carbon fiber, carbon nanofiber, carbon nanotubes, or the like; a metal material such as a metal powder or a metal fiber including copper, nickel, aluminum, silver, or the like; a conductive polymer such as a polyphenylene; or a mixture thereof.

The amount of the first positive electrode conductive material included in the first positive electrode active material layer 111 may be greater than the content of the second positive electrode conductive material included in the second positive electrode active material layer 211. In an implementation, as described above, the content of the first positive electrode conductive material may be 1.2 wt % or more and 3 wt % or less based, on the total weight of the first positive electrode active material layer 111, and the amount of the second positive electrode conductive material may be 1 wt % or more and 1.3 wt % or less based on the total weight of the second positive electrode active material layer 211, (100 wt % of the second positive electrode active material layer 211). Accordingly, the first positive electrode conductive material and the second positive electrode conductive material may help reduce a variation in electrical performance, e.g., an operating voltage, between the first electrode assembly 100 and the second electrode assembly 200 having different positive electrode active materials.

The second positive electrode active material layer 211 may further include a second positive electrode binder.

The second positive electrode binder may help adhere particles constituting the second positive electrode active material to each other well, and adhere the second positive electrode active material to the second positive electrode plate 210 well.

Examples of the second positive electrode binder may include a non-aqueous binder, an aqueous binder, a dry binder, or a combination thereof.

The non-aqueous binder may include polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include styrene-butadiene rubber, (meth)acrylated styrene-butadiene rubber, (meth)acrylonitrile-butadiene rubber, (meth)acrylic rubber, butyl rubber, a fluororubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenolic resin, an epoxy resin, polyvinyl alcohol, or a combination thereof.

In an implementation, the aqueous binder may be used as the second positive electrode binder, and a cellulose compound capable of imparting viscosity may be further included. The cellulose compound may include, e.g., carboxymethyl cellulose, hydroxypropylmethyl cellulose, methyl cellulose, or alkali metal salts thereof. As the alkali metal, Na, K, or Li may be used.

The dry binder may include a fibrous polymer material, e.g., polytetrafluoroethylene, polyvinylidene fluoride, a polyvinylidene fluoride-hexafluoropropylene copolymer, polyethylene oxide, or a combination thereof.

The amount of the first positive electrode binder included in the first positive electrode active material layer 111 may be greater than the amount of the second positive electrode binder included in the second positive electrode active material layer 211. The magnitude of a content ratio of the first positive electrode binder to the first positive electrode active material layer 111 may be greater than the magnitude of a content ratio of the second positive electrode binder to the second positive electrode active material layer 211. In an implementation, as described above, the amount of the first positive electrode binder may be 2.2 wt % or more and 3.8 wt % or less based on the total weight of the first positive electrode active material layer 111, (100 wt % of the first positive electrode active material layer 111), and the amount of the second positive electrode binder may be 1.2 wt % or more and 1.5 wt % or less based on the total weight of the second positive electrode active material layer 211, (100 wt % of the second positive electrode active material layer 211). Accordingly, the first positive electrode binder and the second positive electrode binder may help reduce a variation in electrical performance, such as an operating voltage, between the first electrode assembly 100 and the second electrode assembly 200 having different positive electrode active materials.

The second negative electrode plate 220 may function as a negative electrode of the second electrode assembly 200. The second negative electrode plate 220 may be in the form of a foil including a metal material such as copper, a copper alloy, nickel, or a nickel alloy.

A plurality of second negative electrode plates 220 may be provided. The plurality of second negative electrode plates 220 may be stacked (e.g., side by side) in the vertical direction. Each of the second negative electrode plates 220 may be between a pair of adjacent second positive electrode plates 210. In an implementation, the second positive electrode plate 210 and the second negative electrode plate 220 may be alternately stacked in the vertical direction. The second negative electrode plate 220 may be spaced apart from the second positive electrode plate 210 by a predetermined interval to face the second positive electrode plate 210.

The type, size, and shape of the second negative electrode plate 220 may be suitable types, sizes, and shapes as long as the second negative electrode plate 220 has conductivity and does not cause chemical changes in the secondary battery.

A second negative electrode active material layer 221 may be on the second negative electrode plate 220. The second negative electrode active material layer 221 may be on opposite surfaces of the second negative electrode plate 220 as illustrated in FIG. 2, or alternatively, may be on only one surface of the second negative electrode plate 220.

The second negative electrode active material layer 221 may include a second negative electrode active material.

The second negative electrode active material may include a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may be a carbon negative electrode active material, and examples thereof may include crystalline carbon, amorphous carbon, or a combination thereof. Examples of the crystalline carbon may include graphite such as amorphous, plate-shaped, flake-shaped, spherical-shaped or fiber-shaped natural graphite or artificial graphite. Examples of the amorphous carbon may include soft carbon or hard carbon, a mesophase pitch carbonized product, calcined coke, and the like.

The lithium metal alloy may be an alloy of lithium and a metal, e.g., Na, K, Rb, Cs, Fr, Be, Mg, Ca, Sr, Si, Sb, Pb, In, Zn, Ba, Ra, Ge, Al, or Sn.

A Si negative electrode active material or a Sn negative electrode active material may be used as the material capable of doping and dedoping lithium. The Si negative electrode active material may include silicon, a silicon-carbon composite, SiOₓ (0<x<2), a Si-Q alloy (in which Q is an alkali metal, an alkaline-earth metal, a Group 13 element, a Group 14 element (excluding Si), a Group 15 element, a Group 16 element, a transition metal, a rare-earth element, or a combination thereof), or a combination thereof. The Sn negative electrode active material may include Sn, SnO₂, a Sn alloy, or a combination thereof.

The silicon-carbon composite may be a composite of silicon and amorphous carbon. In an implementation, the silicon-carbon composite may be in the form of silicon particles and amorphous carbon coated on the surface of the silicon particles. In an implementation, the silicon-carbon composite may include a secondary particle (core) in which silicon primary particles are agglomerated and an amorphous carbon coating layer (shell) located on the surface of the secondary particle. The amorphous carbon may also be between the silicon primary particles, e.g., the silicon primary particles may be coated with amorphous carbon. The secondary particles may be dispersed in an amorphous carbon matrix.

The silicon-carbon composite may further include crystalline carbon. In an implementation, the silicon-carbon composite may include a core including crystalline carbon and silicon particles and an amorphous carbon coating layer on the surface of the core.

The Si negative electrode active material or the Sn negative electrode active material may be used by being mixed with a carbon negative electrode active material.

The second negative electrode active material layer 221 may further include a second negative electrode conductive material and a second negative electrode binder.

The second negative electrode conductive material may impart conductivity to the second negative electrode active material layer 221, and a suitable electrically conductive material that does not cause a chemical change in the battery may be used. Examples of the second negative electrode conductive material may include a carbon material such as natural graphite, artificial graphite, carbon black, acetylene black, ketjen black, carbon fiber, carbon nanofiber, carbon nanotubes, or the like; a metal material such as a metal powder or a metal fiber including copper, nickel, aluminum, silver, or the like; a conductive polymer such as a polyphenylene; or a mixture thereof.

The second negative electrode binder may help adhere particles constituting the second negative electrode active material to each other well, and adhere the second negative electrode active material to the second negative electrode plate 220 well.

Examples of the second negative electrode binder may include a non-aqueous binder, an aqueous binder, a dry binder, or a combination thereof.

The non-aqueous binder may include polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include styrene-butadiene rubber, (meth)acrylated styrene-butadiene rubber, (meth)acrylonitrile-butadiene rubber, (meth)acrylic rubber, butyl rubber, a fluororubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenolic resin, an epoxy resin, polyvinyl alcohol, or a combination thereof.

In an implementation, the aqueous binder may be used as the second positive electrode binder, and a cellulose compound capable of imparting viscosity may be further included. In an implementation, the cellulose compound may include carboxymethyl cellulose, hydroxypropylmethyl cellulose, methyl cellulose, or alkali metal salts thereof. As the alkali metal, Na, K, or Li may be used.

The dry binder may include a fibrous polymer material, e.g., polytetrafluoroethylene, polyvinylidene fluoride, a polyvinylidene fluoride-hexafluoropropylene copolymer, polyethylene oxide, or a combination thereof.

The second separator 230 may be between the second positive electrode plate 210 and the second negative electrode plate 220. The second separator 230 may help prevent a short circuit between the second positive electrode plate 210 and the second negative electrode plate 220 while allowing the movement of lithium ions between the second positive electrode plate 210 and the second negative electrode plate 220.

The second separator 230 may be made of, e.g., polyethylene, polypropylene, polyvinylidene fluoride, or a multilayer film of two or more layers thereof, or may be made of a mixed multilayer film, such as, a polyethylene/polypropylene double-layered separator, a polyethylene/polypropylene/polyethylene three-layered separator, and a polypropylene/polyethylene/polypropylene three-layered separator.

The second separator 230 may include a porous substrate, and a coating layer including an organic material, an inorganic material, or a combination thereof on one surface or opposite surfaces of the porous substrate.

The porous substrate may be a polymer film formed of a homopolymer, or a copolymer or mixture of two or more selected from polyolefins such as polyethylene, polypropylene, and the like, a polyester such as polyethylene terephthalate, polybutylene terephthalate, and the like, polyacetal, polyamide, polyimide, polycarbonate, polyetheretherketone, polyaryletherketone, polyetherimide, polyamideimide, polybenzimidazole, polyether sulfone, polyphenylene oxide, a cyclic olefin copolymer, polyphenylene sulfide, polyethylene naphthalate, glass fiber, Teflon, or polytetrafluoroethylene.

The organic material may include a polyvinylidene fluoride polymer or a (meth)acrylic polymer.

The inorganic material may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The organic and inorganic materials may be present by being mixed in one coating layer or may be present in a form in which a coating layer including organic materials and a coating layer including inorganic materials are laminated.

The second separator 230 may be formed as a single piece, e.g., monolithic. The second separator 230 may have a shape bent in a zigzag shape in the horizontal direction or the forward/backward direction, and may be between the second positive electrode plate 210 and the second negative electrode plates 220.

In an implementation, a plurality of second separators 230 may be provided. In an implementation, the plurality of first separators 130 may be individually disposed between the second positive electrode plates 210 and the second negative electrode plates 220 that are adjacent to each other.

The assembly separator 300 can function as a component for mechanically and electrically isolating the first electrode assembly 100 from the second electrode assembly 200.

The assembly separator 300 may include a first assembly separator 310 and a second assembly separator 320.

The first assembly separator 310 may surround an outer region of the first electrode assembly 100 and may function as a component for mechanically (e.g., physically) and electrically isolating the first electrode assembly 100 from the second electrode assembly 200. Accordingly, the first assembly separator 310 may help prevent damage to the first electrode assembly 100 due to external impact, friction, or the like, and may help prevent the first electrode assembly 100 from electrically interfering with the second electrode assembly 200.

The first assembly separator 310 may be made of, e.g., polyethylene, polypropylene, polyvinylidene fluoride, or a multilayer film of two or more layers thereof, or may be made of a mixed multilayer film, such as, a polyethylene/polypropylene double-layered separator, a polyethylene/polypropylene/polyethylene three-layered separator, and a polypropylene/polyethylene/polypropylene three-layered separator.

The first assembly separator 310 may include a porous substrate, and a coating layer including an organic material, an inorganic material, or a combination thereof on one surface or opposite surfaces of the porous substrate.

The porous substrate may be a polymer film formed of a homopolymer, or a copolymer or mixture of two or more selected from polyolefins such as polyethylene, polypropylene, and the like, a polyester such as polyethylene terephthalate, polybutylene terephthalate, and the like, polyacetal, polyamide, polyimide, polycarbonate, polyetheretherketone, polyaryletherketone, polyetherimide, polyamideimide, polybenzimidazole, polyether sulfone, polyphenylene oxide, a cyclic olefin copolymer, polyphenylene sulfide, polyethylene naphthalate, glass fiber, Teflon, or polytetrafluoroethylene.

The organic material may include a polyvinylidene fluoride polymer or a (meth)acrylic polymer.

The inorganic material may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

In an implementation, an adhesive material may be additionally coated on the surface of the first assembly separator 310.

The first assembly separator 310 may be formed of the same material as the first separator 130, or alternatively, may be formed of a material different from that of the first separator 130.

The first assembly separator 310 may be connected to an end portion of the first separator 130 at the uppermost or lowermost end of the first electrode assembly 100. The first assembly separator 310 may be fabricated in a state of being integrally connected to the end portion of the first separator 130, or may be fabricated separately from the first separator 130 and subsequently connected to the end portion of the first separator 130. The first assembly separator 310 may surround a circumferential surface of the first electrode assembly 100 in a clockwise or counterclockwise direction. In an implementation, the first assembly separator 310 may surround the circumferential surface of the first electrode assembly 100 with respect to a direction perpendicular to a stacking direction of the first electrode assembly 100 and the second electrode assembly 200. In an implementation, referring to FIG. 1, the first assembly separator 310 may surround the circumferential surface of the first electrode assembly 100 with respect to the forward/backward direction. In an implementation, the first assembly separator 310 may surround the circumferential surface of the first electrode assembly 100 with respect to the horizontal direction.

At least a partial region of the first assembly separator 310 may be between the first electrode assembly 100 and the second electrode assembly 200. Accordingly, the first assembly separator 310 may help prevent direct contact from occurring between the first electrode assembly 100 and the second electrode assembly 200.

A first open side or first open surface 311 that exposes end surfaces of the first positive electrode plate 110 and the first negative electrode plate 120 to the outside may be formed in the first assembly separator 310. A pair of first open surfaces 311 may be provided. The pair of first open surfaces 311 may be opposite to each other in the direction perpendicular to the stacking direction of the first electrode assembly 100 and the second electrode assembly 200. In an implementation, the pair of first open surfaces 311 may respectively face front and rear end surfaces of the first electrode assembly 100, e.g., the first positive electrode plate 110 and the first negative electrode plate 120. In an implementation, the pair of first open surfaces 311 may respectively face left and right end surfaces of the first positive electrode plate 110 and the first negative electrode plate 120.

The second assembly separator 320 may surround an outer region of the second electrode assembly 200, and may function as a component for mechanically and electrically isolating the second electrode assembly 200 from the first electrode assembly 100. Accordingly, the second assembly separator 320 may help prevent damage to the second electrode assembly 200 due to external impact, friction, or the like, and may help prevent the second electrode assembly 200 from electrically interfering with the first electrode assembly 100.

The second assembly separator 320 may be made of polyethylene, polypropylene, polyvinylidene fluoride, or a multilayer film of two or more layers thereof, and may also be made of a mixed multilayer film, such as, a polyethylene/polypropylene double-layered separator, a polyethylene/polypropylene/polyethylene three-layered separator, and a polypropylene/polyethylene/polypropylene three-layered separator.

The second assembly separator 320 may include a porous substrate, and a coating layer including an organic material, an inorganic material, or a combination thereof on one surface or opposite surfaces of the porous substrate.

The porous substrate may be a polymer film formed of a homopolymer, or a copolymer or mixture of two or more selected from polyolefins such as polyethylene, polypropylene, and the like, a polyester such as polyethylene terephthalate, polybutylene terephthalate, and the like, polyacetal, polyamide, polyimide, polycarbonate, polyetheretherketone, polyaryletherketone, polyetherimide, polyamideimide, polybenzimidazole, polyether sulfone, polyphenylene oxide, a cyclic olefin copolymer, polyphenylene sulfide, polyethylene naphthalate, glass fiber, Teflon, or polytetrafluoroethylene.

The organic material may include a polyvinylidene fluoride polymer or a (meth)acrylic polymer.

The inorganic material may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

In an implementation, an adhesive material may be additionally coated on the surface of the second assembly separator 320.

The second assembly separator 320 may be formed of the same material as the second separator 230, or alternatively, may be formed of a material different from that of the second separator 230.

The second assembly separator 320 may be connected to an end portion of the second separator 230 at the uppermost end or the lowermost end of the second electrode assembly 200. The second assembly separator 320 may be fabricated in a state of being integrally connected to the end portion of the second separator 230, or may be fabricated separately from the second separator 230 and subsequently connected to the end portion of the second separator 230. The second assembly separator 320 may surround a circumferential surface of the second electrode assembly 200 in a clockwise or counterclockwise direction. In an implementation, the second assembly separator 320 may surround the circumferential surface of the second electrode assembly 200 with respect to a direction perpendicular to the stacking direction of the first electrode assembly 100 and the second electrode assembly 200. In an implementation, referring to FIG. 1, the second assembly separator 320 may surround the circumferential surface of the second electrode assembly 200 with respect to the forward/backward direction. In an implementation, the second assembly separator 320 may surround the circumferential surface of the second electrode assembly 200 with respect to the horizontal direction.

At least a partial region of the second assembly separator 320 may be between the first electrode assembly 100 and the second electrode assembly 200. Accordingly, the second assembly separator 320 may help prevent direct contact between the first electrode assembly 100 and the second electrode assembly 200. The second assembly separator 320 between the first electrode assembly 100 and the second electrode assembly 200 may be in contact with the first assembly separator 310 between the first electrode assembly 100 and the second electrode assembly 200.

A second open side or second open surface 321 that exposes end surfaces of the second positive electrode plate 210 and the second negative electrode plate 220 to the outside may be in the second assembly separator 320. A pair of second open surfaces 321 may be provided. The pair of second open surfaces 321 may be opposite to each other in the direction perpendicular to the stacking direction of the first electrode assembly 100 and the second electrode assembly 200. In an implementation, the pair of second open surfaces 321 may respectively face front and rear end surfaces of the second electrode assembly 200, e.g., the second positive electrode plate 210 and the second negative electrode plate 220. In an implementation, the pair of second open surfaces 321 may respectively face left and right end surfaces of the second positive electrode plate 210 and the second negative electrode plate 220.

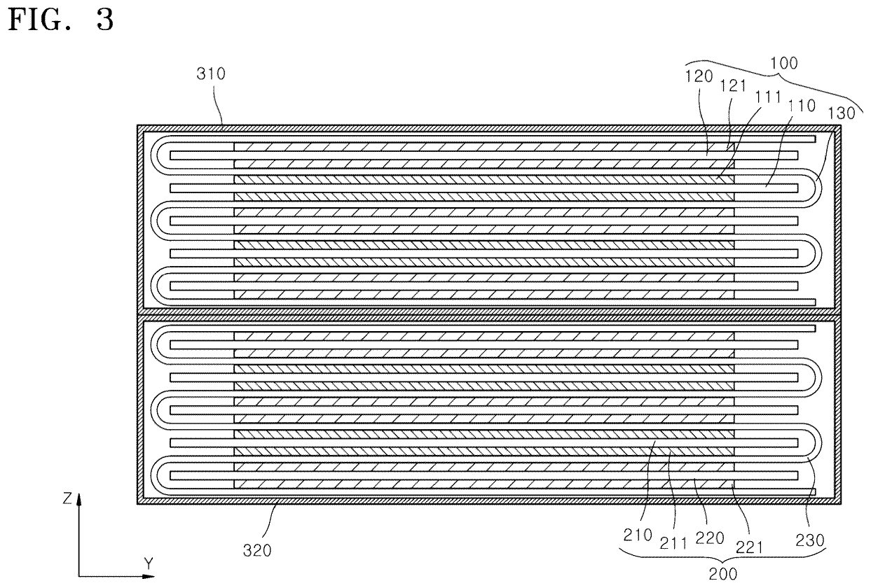

FIG. 3 is a view illustrating a modified example of the first assembly separator and the second assembly separator illustrated in FIG. 2.

Referring to FIG. 3, the first assembly separator 310 may be separated from the end portion of the first separator 130. In this case, the first assembly separator 310 may have a ring or closed loop shape in which a pair of first open surfaces 311 are on opposite surfaces thereof. The first assembly separator 310 may be disposed such that an inner side surface thereof surrounds the circumferential surface of the first electrode assembly 100. In an implementation, the inner side surface of the first assembly separator 310 may be fixed to the circumferential surface of the first electrode assembly 100 through an adhesive or the like. At least a partial region or part of the first assembly separator 310 may be between the first electrode assembly 100 and the second electrode assembly 200. The pair of first open surfaces 311 may respectively face the front and rear or left and right end surfaces of the first positive electrode plate 110 and the first negative electrode plate 120 of the first electrode assembly 100.

The second assembly separator 320 may be separated from the end portion of the second separator 230. In this case, the second assembly separator 320 may have a ring or closed loop shape in which a pair of second open surfaces 321 are on opposite surfaces thereof. The second assembly separator 320 may be disposed such that an inner side surface thereof surrounds the circumferential surface of the second electrode assembly 200. In an implementation, the inner side surface of the second assembly separator 320 may be fixed to the circumferential surface of the second electrode assembly 200 through an adhesive or the like. At least a partial region or part of the second assembly separator 320 may be between the first electrode assembly 100 and the second electrode assembly 200. The pair of second open surfaces 321 may respectively face the front and rear or left and right end surfaces of the second positive electrode plate 210 and the second negative electrode plate 220 of the second electrode assembly 200.

The first electrode assembly 100 according to the present embodiment may further include a first positive electrode tab 140 and a first negative electrode tab 150, and the second electrode assembly 200 may further include a second positive electrode tab 240 and a second negative electrode tab 250.

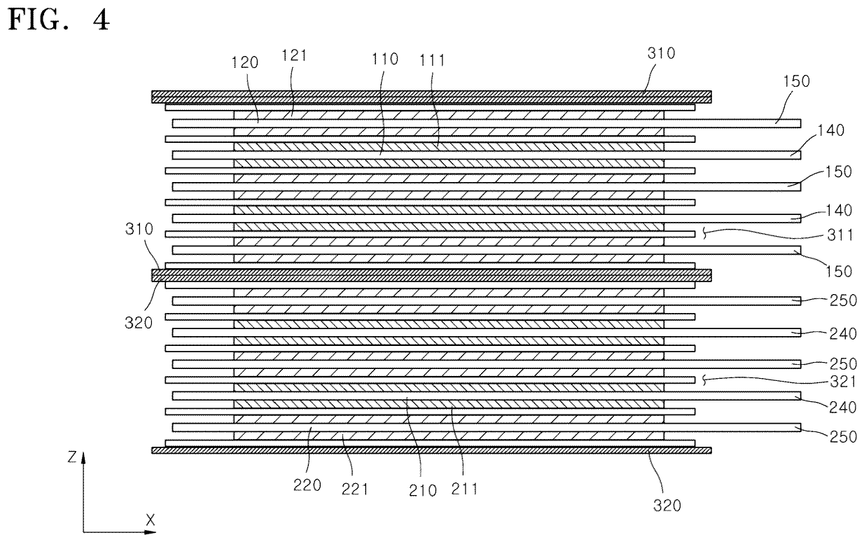

FIG. 4 is a cross-sectional view taken along line B-B′ of FIG. 1.

Referring to FIGS. 1 and 4, the first positive electrode tab 140 may extend from the first positive electrode plate 110 to the outside of the first assembly separator 310. In an implementation, the first positive electrode tab 140 may extend from an end portion of the first positive electrode plate 110 facing the first open surface 311, and may extend to the outside of the first assembly separator 310 through the first open surface 311. The first positive electrode tab 140 may be formed of the same material as the first positive electrode plate 110. The first positive electrode tab 140 may be fabricated integrally with the first positive electrode plate 110 by notching or the like, or alternatively, the first positive electrode tab 140 may be fabricated separately from the first positive electrode plate 110 and subsequently connected to the first positive electrode plate 110. A plurality of first positive electrode tabs 140 may be provided. The plurality of first positive electrode tabs 140 may individually extend from different first positive electrode plates 110. The plurality of first positive electrode tabs 140 may be in parallel to face each other in the stacking direction of the first positive electrode plate 110 and the first negative electrode plate 120.

The first negative electrode tab 150 may extend from the first negative electrode plate 120 to the outside of the first assembly separator 310. In an implementation, the first negative electrode tab 150 may extend from an end portion of the first negative electrode plate 120 facing the first open surface 311, and may extend to the outside of the first assembly separator 310 through the first open surface 311. The first negative electrode tab 150 may be formed of the same material as the first negative electrode plate 120. The first negative electrode tab 150 may be fabricated integrally with the first negative electrode plate 120 by notching or the like, or alternatively, the first negative electrode tab 150 may be fabricated separately from the first negative electrode plate 120 and subsequently connected to the first positive electrode plate 110. A plurality of first negative electrode tabs 150 may be provided. The plurality of first negative electrode tabs 150 may individually extend from different first negative electrode plates 120. The plurality of first negative electrode tabs 150 may be in parallel to face each other in the stacking direction of the first positive electrode plate 110 and the first negative electrode plate 120.

The first positive electrode tab 140 and the first negative electrode tab 150 may extend to the outside of the first assembly separator 310 through the same one of the pair of first open surfaces 311. In this case, the first positive electrode tab 140 and the first negative electrode tab 150 may be offset from each other in the stacking direction of the first positive electrode plate 110 and the first negative electrode plate 120. In an implementation, the first positive electrode tab 140 and the first negative electrode tab 150 may be (e.g., laterally) spaced apart from each other in the horizontal direction.

The second positive electrode tab 240 may extend from the second positive electrode plate 210 to the outside of the second assembly separator 320. In an implementation, the second positive electrode tab 240 may extend from an end portion of the second positive electrode plate 210 facing the second open surface 321, and may extend to the outside of the second assembly separator 320 through the second open surface 321. The second positive electrode tab 240 may be formed of the same material as the second positive electrode plate 210. The second positive electrode tab 240 may be fabricated integrally with the second positive electrode plate 210 by notching or the like, or alternatively, the second positive electrode tab 240 may be fabricated separately from the second positive electrode plate 210 and subsequently connected to the second positive electrode plate 210. A plurality of second positive electrode tabs 240 may be provided. The plurality of second positive electrode tabs 240 may individually extend from different second positive electrode plates 210. The plurality of second positive electrode tabs 240 may be in parallel to face each other in a stacking direction of the second positive electrode plate 210 and the second negative electrode plate 220.

The second negative electrode tab 250 may extend from the second negative electrode plate 220 to the outside of the second assembly separator 320. In an implementation, the second negative electrode tab 250 may extend from an end portion of the second negative electrode plate 220 facing the second open surface 321, and may extend to the outside of the second assembly separator 320 through the second open surface 321. The second negative electrode tab 250 may be formed of the same material as the second negative electrode plate 220. The second negative electrode tab 250 may be fabricated integrally with the second negative electrode plate 220 by notching or the like, or alternatively, the second negative electrode tab 250 may be fabricated separately from the second negative electrode plate 220 and subsequently connected to the second negative electrode plate 220. A plurality of second negative electrode tabs 250 may be provided. The plurality of second negative electrode tabs 250 may individually extend from different second negative electrode plates 220. The plurality of second negative electrode tabs 250 may be in parallel to face each other in the stacking direction of the second positive electrode plate 210 and the second negative electrode plate 220.

The second positive electrode tab 240 and the second negative electrode tab 250 may extend to the outside of the second assembly separator 320 through the same one of the pair of second open surfaces 321. In this case, the second positive electrode tab 240 and the second negative electrode tab 250 may be offset from each other in the stacking direction of the second positive electrode plate 210 and the second negative electrode plate 220. In an implementation, the second positive electrode tab 240 and the second negative electrode tab 250 may be spaced apart from each other in the horizontal direction.

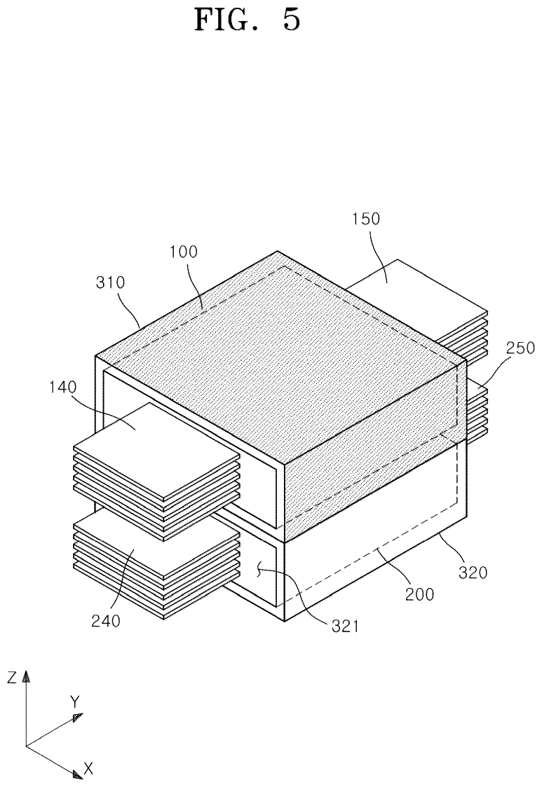

FIG. 5 is a perspective view illustrating a modified example of the first positive electrode tab, the first negative electrode tab, the second positive electrode tab, and the second negative electrode tab illustrated in FIGS. 1 and 4, and FIG. 6 is a cross-sectional view illustrating the modified example of the first positive electrode tab, the first negative electrode tab, the second positive electrode tab, and the second negative electrode tab illustrated in FIGS. 1 and 4.

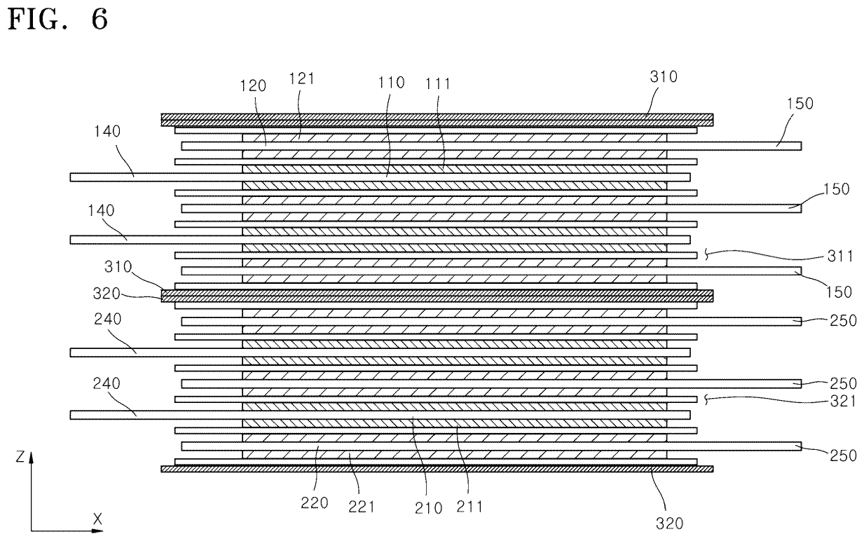

Referring to FIGS. 5 and 6, the first positive electrode tab 140 and the first negative electrode tab 150 may extend to the outside of the first assembly separator 310 through different first open surfaces 311. In an implementation, the first positive electrode tab 140 may extend from an end portion of the first positive electrode plate 110, facing one of the pair of first open surfaces 311 where both end portions of the first positive electrode plate 110 individually face, and the first negative electrode tab 150 may extend from an end portion of the first negative electrode plate 120, facing the other one of the pair of first open surfaces 311 where both end portions of the first negative electrode plate 120 individually face.

The second positive electrode tab 240 and the second negative electrode tab 250 may extend to the outside of the second assembly separator 320 through different second open surfaces 321. In an implementation, the second positive electrode tab 240 may extend from an end portion of the second positive electrode plate 210, facing one of the pair of second open surface 321 where both end portions of the second positive electrode plate 210 individually face, and the second negative electrode tab 250 may extend from an end portion of the second negative electrode plate 220, facing the other one of the pair of second open surface 321 where both end portions of the second negative electrode plate 220 individually face.

In an implementation, the secondary battery according to the present embodiment may further include a battery case accommodating the first electrode assembly 100 and the second electrode assembly 200 together with an electrolyte, and an electrode lead electrically connected to the first positive electrode tab 140, the first negative electrode tab 150, the second positive electrode tab 240, and the second negative electrode tab 250 and protruding to the outside of the battery case.

Hereinafter, a secondary battery according to another embodiment will be described.

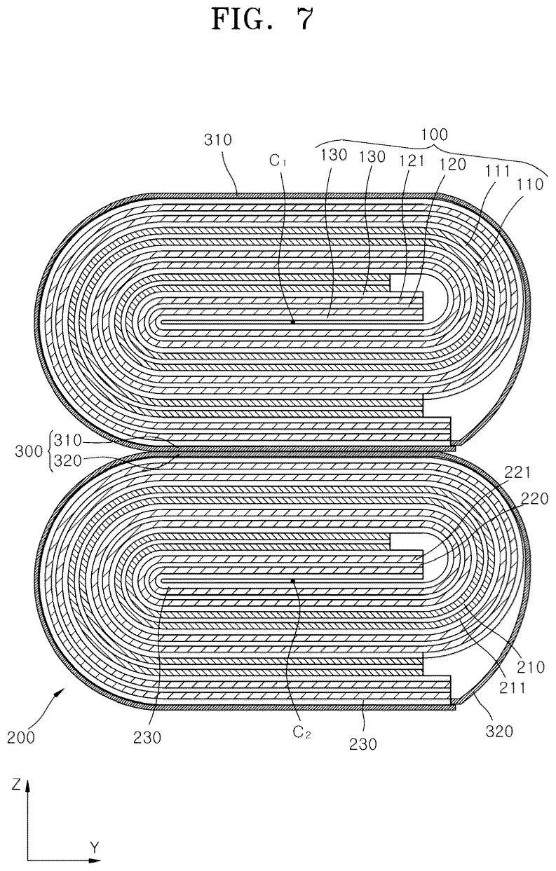

FIG. 7 is a cross-sectional view schematically illustrating a configuration of the secondary battery according to another embodiment.

The secondary battery according to the present embodiment may be configured by varying only a detailed configuration of the first electrode assembly 100 and the second electrode assembly 200 from the secondary battery described based on FIGS. 1 to 6.

Accordingly, in describing the secondary battery according to the present embodiment, only the detailed configuration of the first electrode assembly 100 and the second electrode assembly 200, which is different from that of the secondary battery described based on FIGS. 1 to 6 will be described.

The description of the secondary battery according to an embodiment provided based on FIGS. 1 to 6 may be applied to the remaining components of the secondary battery according to the present embodiment.

Referring to FIG. 7, the first positive electrode plate 110 and the first negative electrode plate 120 may (e.g., each) be formed as a single piece. The first positive electrode plate 110 and the first negative electrode plate 120 may be wound clockwise or counterclockwise around a winding axis C₁ while one surfaces thereof face each other. Accordingly, the first electrode assembly 100 may have substantially a jelly roll shape. In an implementation, a cross-sectional shape of the first electrode assembly 100 may be changed in design into various shapes such as a circular shape, a polygonal shape, or the like, in addition to an elliptical shape as illustrated in FIG. 7. Here, the winding axis C₁ may be a straight line passing through a central part of the first electrode assembly 100 and disposed perpendicular to a first open surface 311.

A pair of first separators 130 may be provided. The pair of first separators 130 may face opposite surfaces of the first positive electrode plate 110 or the first negative electrode plate 120, respectively. The pair of first separators 130 may be wound around the winding axis C₁ together with the first positive electrode plate 110 and the first negative electrode plate 120.

The second positive electrode plate 210 and the second negative electrode plate 220 may (e.g., each) be formed as a single piece. The second positive electrode plate 210 and the second negative electrode plate 220 may be wound clockwise or counterclockwise around a winding axis C₂ while one surfaces thereof face each other. Accordingly, the second electrode assembly 200 may have a substantially jelly roll shape. A cross-sectional shape of the second electrode assembly 200 may be changed in design into various shapes such as a circular shape, a polygonal shape, or the like in addition to an elliptical shape as illustrated in FIG. 7. Here, the winding axis C₂ may be a straight line passing through a central part of the second electrode assembly 200 and disposed perpendicular to a second open surface 321.

A pair of second separators 230 may be provided. The pair of second separators 230 may face opposite surfaces of the second positive electrode plate 210 or the second negative electrode plate 220, respectively. The pair of second separators 230 may be wound around the winding axis C₂ together with the second positive electrode plate 210 and the second negative electrode plate 220.

The first assembly separator 310 may be connected to an outer end portion of any one of the pair of first separators 130 and may extend to surround a circumferential surface of the first electrode assembly 100 in a clockwise or counterclockwise direction. In an implementation, a cross-sectional shape of the first assembly separator 310 may be changed in design into various shapes such as a circular shape, a polygonal shape, or the like in addition to an elliptical shape shown in FIG. 7.

The second assembly separator 320 may be connected to an outer end portion of any one of the pair of second separators 230 and may extend to surround a circumferential surface of the second electrode assembly 200 clockwise or counterclockwise In an implementation, a cross-sectional shape of the second assembly separator 320 may be changed in design into various shapes such as a circular shape, a polygonal shape, or the like in addition to an elliptical shape shown in FIG. 7.

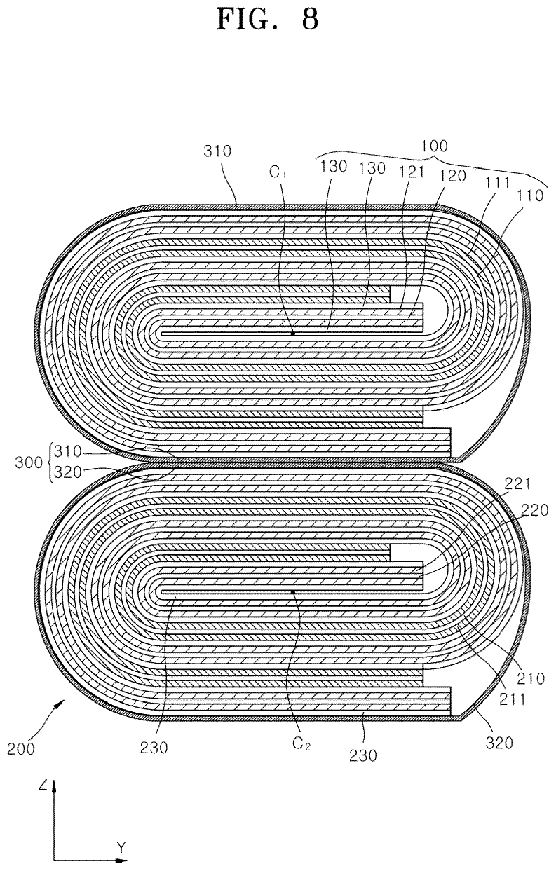

FIG. 8 is a view illustrating a modified example of the first assembly separator and the second assembly separator illustrated in FIG. 7.

Referring to FIG. 8, the first assembly separator 310 may be separated from an end portion of the first separator 130. In this case, the first assembly separator 310 may have a ring or closed loop shape in which a pair of first open surfaces 311 are on opposite surfaces thereof. The first assembly separator 310 may be disposed such that an inner side surface thereof surrounds the circumferential surface of the first electrode assembly 100.

The second assembly separator 320 may be separated from an end portion of the second separator 230. In this case, the second assembly separator 320 may have a ring or closed loop shape in which a pair of second open surfaces 321 are on opposite surfaces thereof. The second assembly separator 320 may be disposed such that an inner side surface thereof surrounds the circumferential surface of the second electrode assembly 200.

Hereinafter, a secondary battery according to another embodiment will be described.

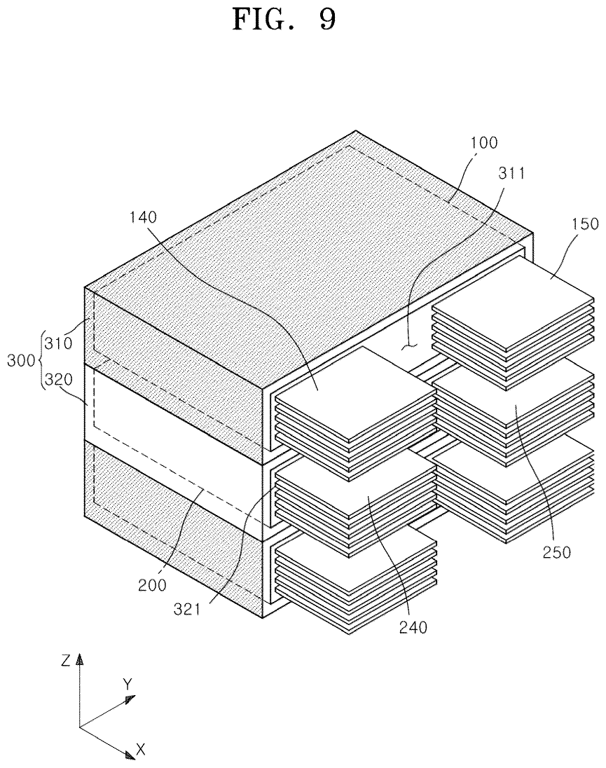

FIG. 9 is a perspective view schematically illustrating a configuration of the secondary battery according to another embodiment.

The secondary battery according to the present embodiment may be configured by varying only the arrangement structure the first electrode assembly 100 and the second electrode assembly 200 from the secondary battery described based on FIGS. 1 to 6 and the secondary battery described based on FIGS. 7 and 8.

Accordingly, in describing the secondary battery according to the present embodiment, only the arrangement structure of the first electrode assembly 100 and the second electrode assembly 200 different from the secondary battery described based on FIGS. 1 to 6 and the secondary battery described based on FIGS. 7 and 8 will be described.

Detailed configurations of the first electrode assembly 100, the second electrode assembly 200, and the assembly separator 300 according to the present embodiment may be the same as those of the secondary battery described based on FIGS. 1 to 6 or the secondary battery described based on FIGS. 7 and 8.

Referring to FIG. 9, a pair of first electrode assemblies 100 may be provided, and the second electrode assembly 200 may be between the pair of first electrode assemblies 100. In an implementation, the secondary battery according to the present embodiment may have a structure in which the first electrode assembly 100 and the second electrode assembly 200 are alternately stacked in three layers.

Hereinafter, a secondary battery according to another embodiment will be described.

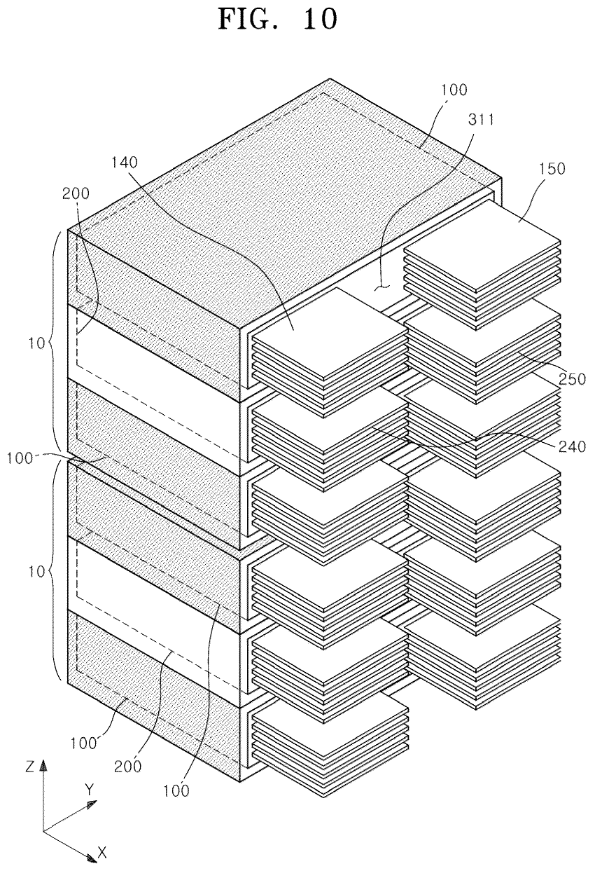

FIG. 10 is a perspective view schematically illustrating a configuration of the secondary battery according to another embodiment.

Referring to FIG. 10, the secondary battery according to the present embodiment may include a plurality of assembly modules 10.

Each of the assembly modules 10 may include a pair of first electrode assemblies 100, the second electrode assembly 200 between the pair of first electrode assemblies 100, and the assembly separator 300 separating the first electrode assembly 100 and the second electrode assembly 200 from each other.

In an implementation, each of the assembly modules 10 may have the same configuration as the secondary battery described based on FIG. 9. The detailed configurations of the first electrode assembly 100, the second electrode assembly 200, and the assembly separator 300 may be the same as the detailed configurations of the first electrode assembly 100, the second electrode assembly 200, and the assembly separator 300 described based on FIGS. 1 to 6 or the first electrode assembly 100, the second electrode assembly 200, and the assembly separator 300 described based on FIGS. 7 and 8.

The plurality of assembly modules 10 may be stacked side by side in one direction. A stacking direction of the plurality of assembly modules 10 may be the same as the stacking direction of the first electrode assembly 100 and the second electrode assembly 200. In an implementation, the plurality of assembly modules 10 may be stacked side by side in the vertical direction.

According to an embodiment, by mixing and arranging a first electrode assembly and a second electrode assembly, which include different positive electrode active materials, operation stability of a cell may be ensured, and the limitation of limited internal space of the cell can be overcome, thereby increasing energy density.

According to an embodiment, the first electrode assembly and the second electrode assembly may be prevented from mechanically and electrically interfering with each other by an assembly separator.

According to the embodiment, the first electrode assembly having a positive electrode active material with a relatively low specific capacity may have a larger ratio of conductive material and binder content compared to the second electrode assembly, so that occurrence of excessive variation in electrical performance between the first electrode assembly and the second electrode assembly may be prevented.

One or more embodiments may provide a secondary battery with increased energy density.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
at least one first electrode assembly comprising:
at least one first positive electrode plate comprising a first positive electrode active material layer thereon, the first positive electrode active material layer comprising a first positive electrode active material,
at least one first negative electrode plate facing the at least one first positive electrode plate, and
a first separator between the at least one first positive electrode plate and the at least one first negative electrode plate;
a second electrode assembly comprising:
a second positive electrode plate comprising a second positive electrode active material layer thereon, the second positive electrode active material layer comprising a second positive electrode active material different from the first positive electrode active material,
a second negative electrode plate facing the second positive electrode plate, and
a second separator between the second positive electrode plate and the second negative electrode plate; and
an assembly separator separating the at least one first electrode assembly and the second electrode assembly from each other.

2. The secondary battery as claimed in claim 1, wherein the at least one first electrode assembly and the second electrode assembly are alternately stacked.

3. The secondary battery as claimed in claim 1, wherein:
the at least one first electrode assembly comprises a pair of first electrode assemblies, and
the second electrode assembly is between the pair of first electrode assemblies.

4. The secondary battery as claimed in claim 1, wherein:
the at least one first positive electrode plate comprises a plurality of first positive electrode plates,
the at least one first negative electrode plate comprises a plurality of first negative electrode plates, and
the plurality of first positive electrode plates and the plurality of first negative electrode plates are alternately stacked.

5. The secondary battery as claimed in claim 1, wherein the at least one first positive electrode plate and the at least one first negative electrode plate are wound around a winding axis.

6. The secondary battery as claimed in claim 1, wherein:
the first positive electrode active material comprises lithium-iron-phosphate oxide (LiFePO₄, LFP) or lithium-manganese-iron-phosphate oxide (LiMnFePO₄, LMFP), and
the second positive electrode active material comprises lithium-nickel-cobalt-manganese oxide (LiNiₓCo_{y}Mn_{z}O₂, NCM), in which 0<x<1, 0<y<1, 0<z<1, and x+y+z=1.

7. The secondary battery as claimed in claim 6, wherein:
the first positive electrode active material layer further comprises a first positive electrode conductive material,
the second positive electrode active material layer further comprises a second positive electrode conductive material, and
an amount of the first positive electrode conductive material included in the first positive electrode active material layer is greater than an amount of the second positive electrode conductive material included in the second positive electrode active material layer.

8. The secondary battery as claimed in claim 7, wherein:
the amount of the first positive electrode conductive material included in the first positive electrode active material layer is 1.2 wt % or more and 3 wt % or less, based on a total weight of the first positive electrode active material layer, and
the amount of the second positive electrode conductive material included in the second positive electrode active material layer is 1 wt % or more and 1.3 wt % or less, based on a total weight of the second positive electrode active material layer.

9. The secondary battery as claimed in claim 6, wherein:
the first positive electrode active material layer further comprises a first positive electrode binder,
the second positive electrode active material layer further comprises a second positive electrode binder, and
an amount of the first positive electrode binder included in the first positive electrode active material layer is greater than an amount of the second positive electrode binder included in the second positive electrode active material layer.

10. The secondary battery as claimed in claim 9, wherein:
the amount of the first positive electrode binder included in the first positive electrode active material layer is 2.2 wt % or more and 3.8 wt % or less, based on a total weight of the first positive electrode active material layer, and
the amount of the second positive electrode binder included in the second positive electrode active material layer is 1.2 wt % or more and 1.5 wt % or less, based on a total weight of the second positive electrode active material layer.

11. The secondary battery as claimed in claim 1, wherein:
the at least one first negative electrode plate comprises a first negative electrode active material layer thereon, the first negative electrode active material layer comprising a first negative electrode active material,
the second negative electrode plate comprises a second negative electrode active material layer thereon, the second negative electrode active material layer comprising a second negative electrode active material, and
the first negative electrode active material and the second negative electrode active material are identical.

12. The secondary battery as claimed in claim 11, wherein each of the first negative electrode active material and the second negative electrode active material comprises graphite or silicon (Si).

13. The secondary battery as claimed in claim 1, wherein the assembly separator comprises:
a first assembly separator surrounding the at least one first electrode assembly; and
a second assembly separator surrounding the second electrode assembly.

14. The secondary battery as claimed in claim 13, wherein the first assembly separator:
is connected to an end portion of the first separator, and
extends along a circumferential surface of the at least one first electrode assembly.

15. The secondary battery as claimed in claim 13, wherein the first assembly separator:
is separated from the first separator, and
is at least partially between the at least one first electrode assembly and the second electrode assembly.

16. The secondary battery as claimed in claim 13, wherein the at least one first electrode assembly further comprises:
a first positive electrode tab extending from the at least one first positive electrode plate to the outside of the first assembly separator; and
a first negative electrode tab extending from the at least one first negative electrode plate to the outside of the first assembly separator.

17. The secondary battery as claimed in claim 16, wherein:
the first assembly separator comprises a pair of first open surfaces respectively facing opposite surfaces of the at least one first electrode assembly, and
the first positive electrode tab and the first negative electrode tab extend to the outside of the first assembly separator through different first open surfaces.

18. The secondary battery as claimed in claim 16, wherein:
the first assembly separator comprises a pair of first open surfaces respectively facing opposite surfaces of the at least one first electrode assembly, and
the first positive electrode tab and the first negative electrode tab extend to the outside of the first assembly separator through the same first open surface.

19. A secondary battery, comprising:
a plurality of assembly modules each comprising a pair of first electrode assemblies having a first positive electrode active material, a second electrode assembly having a second positive electrode active material different from the first positive electrode active material and between the pair of first electrode assemblies, and an assembly separator separating the pair of first electrode assemblies and the second electrode assembly from each other,
wherein the plurality of assembly modules are stacked side by side in one direction.
